(19) United States
(12) Patent Application Publication
(10) Pub. No.: US 2022/0366366 A1
(43) Pub. Date: Nov. 17, 2022

(54) SYSTEMS AND METHODS TO TRACK ASSETS USING ACTIVE DEVICES AND PASSIVE DEVICES

(71) Applicant: BEAMLIVE INC, Woodside, CA (US)

(72) Inventors: Mehrdad Negahban, Woodside, CA (US); Craig Bell, New South Wales (AU)

(21) Appl. No.: 17/322,852

(22) Filed: May 17, 2021

(51) Int. Cl. G06Q 10/08; G06K 19/06; G06K 19/07; H04W 4/021

(52) U.S. Cl. CPC G06Q 10/0833; G06K 19/06028; G06K 19/0723; H04W 4/021

(57) ABSTRACT

This disclosure presents systems and methods to track assets using active devices and passive devices. Exemplary implementations may: obtain passive report information and/or active report information; generate event records based on the passive report information and/or the active report information, the events records being indicative of physical movement of one or more assets carrying the one or more passive devices; generate pages providing access to the event records; and/or perform other features and/or functionality.

### FIELD

This disclosure relates to systems and methods to track assets using active devices and passive devices.

### BACKGROUND

When shipping packages, some companies provide its customer with updates about the packages' location. Typically, these updates come from reading, or scanning, a barcode or RFID tag on the package itself when it gets to certain waypoints along its shipping route. These waypoints may include, for example, a shipping origin when the package is initially sent out for shipping, a warehouse where the package is being transferred, and/or a destination when the package is delivered.

### SUMMARY

Typical methods of tracking may only provide discrete updates as to the whereabouts of an asset. These updates may be provided at each instance that a barcode or passive RFID tag is read or scanned by a scanner. Sometimes, if an asset is carried by a delivery vehicle, estimates may be provided as to an arrival time of the vehicle to a certain destination and/or approximate location of the vehicle based on an expected route of the vehicle. These methods, however, do not provide live, real-time tracking.

One or more aspects of the disclosure provide improvements in tracking technologies through systems and methods configured to track assets using active devices and passive devices. Passive devices may include electronic components and/or other physical components that may not require an external power source to function. By way of non-limiting illustration, a passive device may include one or more of a passive radio-frequency identification (RFID) device (or tag), a barcode (e.g., a matrix barcode such as a QR code, a linear barcode such as UPC barcode, and/or other barcodes), and/or other components. Active devices may comprise electronic circuitry and/or other components that may rely on an external power source to control or modify electrical signals. By way of non-limiting illustration, an active device may include a computing platform. A computing platform may include one or more of a power source (e.g., a battery), processor(s), one or more transceivers to wirelessly communicate information with a network, one or more sensors (e.g., image sensor, GPS, and/or other sensors) and/or other components.

A passive device may provide tracking-related information for an asset at discrete points in time and/or at discrete locations. By way of non-limiting illustration, at an instance where the passive device is detected (e.g., read and/or scanned), information related to one or more of location, identification, and/or other information related to the passive device may be obtained. An active device may be configured to detect the passive device to obtain and/or generate the information related to the passive device. The active device may be carried by a person and/or coupled to a vehicle which thereafter transports the asset having the passive device. After the passive device is read by the active device, the tracking may be “handed off” to the active device to provide live, real-time or near real-time, tracking based on sensors coupled to the active device (e.g., GPS and/or other sensors). At another point in time, the passive device may be detected again by the active device and/or one or more other active devices. The detection at the other point in time may correspond to a transfer of the asset to another entity (e.g., driver and/or vehicle) and/or location (e.g., a warehouse). When the passive device is detected at the other point in time, information related to one or more of location, identification, and/or other information about the passive device may again be obtained. Thus detection may correspond to the tracking being “handed off” back to the passive device. After the passive device is read by the active device and/or the one or more other active devices, the tracking may yet again be “handed off” to the active device and/or the one or more other active devices to provide live, real-time or near real-time, tracking based on sensors coupled thereto. The process may be carried out until the asset arrives at a destination.

One or more implementations of a system configured to track assets using active devices and passive devices may include one or more of one or more servers, one or more passive devices, one or more active devices, and/or other components. The one or more servers may include one or more physical processors and/or other components. The one or more servers may communicate with one or more passive devices, one or more active devices, and/or other components of the system via client/server architecture, and/or other communication schemes. The one or more physical processors may be configured by machine-readable instructions. Executing the machine-readable instructions may cause the one or more physical processor to facilitate tracking assets using one or more of active devices, passive devices, and/or other components. The machine-readable instructions may include one or more computer program components. The computer program components may include one or more of a communication component, a record component, a page component and/or other components.

The communication component may be configured to obtain one or more of information related to individual passive devices, information related to individual active devices, and/or other information. The information related to individual passive devices may include passive report information for one or more passive devices and/or other information. The information related to individual active devices may include active report information for one or more active devices and/or other information. The passive report information may convey one or more of detection of the one or more passive devices, identification of the one or more passive devices, location of the one or more passive devices, and/or other information. The active report information may convey one or more of identification of the one or more active devices, location of the one or more active devices, and/or other information.

The record component may be configured to generate event records. The event records may be generated based on information obtained by the communication component. The record component may be configured to generate event records based on one or more of the passive report information, the active report information, and/or other information. The events records may be indicative of physical movement of one or more assets carrying the one or more passive devices. By way of non-limiting illustration, the event records may include one or more passive reporting event records, one or more active reporting event records, and/or other records.

An individual passive reporting event record may be generated in response to the passive report information for an individual passive device being obtained and/or in response to other triggers. The individual passive reporting event record may include one or more of indication of detection of an individual passive device, identification of the individual passive device, location of the individual passive device, and/or other information. By way of non-limiting illustration, a first passive reporting event record may be generated in response to obtaining first passive report information for a first passive device. The first passive reporting event record may include one or more of an identification of the first passive device, a first location of the first passive device, and/or other information.

An individual active reporting event record may be generated in response to active report information for an individual active device being obtained and/or in response to other triggers. The individual active reporting event record may include one or more of an identification of an individual active device, location of the individual active device, and/or other information. By way of non-limiting illustration, a first active reporting event may be generated in response to obtaining first active report information for a first active device. The first active reporting event record may include an identification of the first active device, location of the first active device, and/or other information.

In some implementations, the record component may be configured to organize the event records to generate a series of the event records. A series of event records may organize the event records in chronological order with respect to when the active report information and the passive report information are obtained. Accordingly, the series of the event records may convey a timeline of physical movement of one or more assets carrying the one or more passive device.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to track assets using active devices and passive devices, in accordance with one or more implementations.

FIG. 2 illustrates a method to track assets using active devices and passive devices, in accordance with one or more implementations.

FIG. 3 illustrates an implementation of a system configured to track assets using active devices and passive devices.

FIG. 4 illustrates an active device and a user interface in accordance with one or more implementations.

FIG. 5 illustrates a user interface in accordance with one or more implementations.

### DETAILED DESCRIPTION

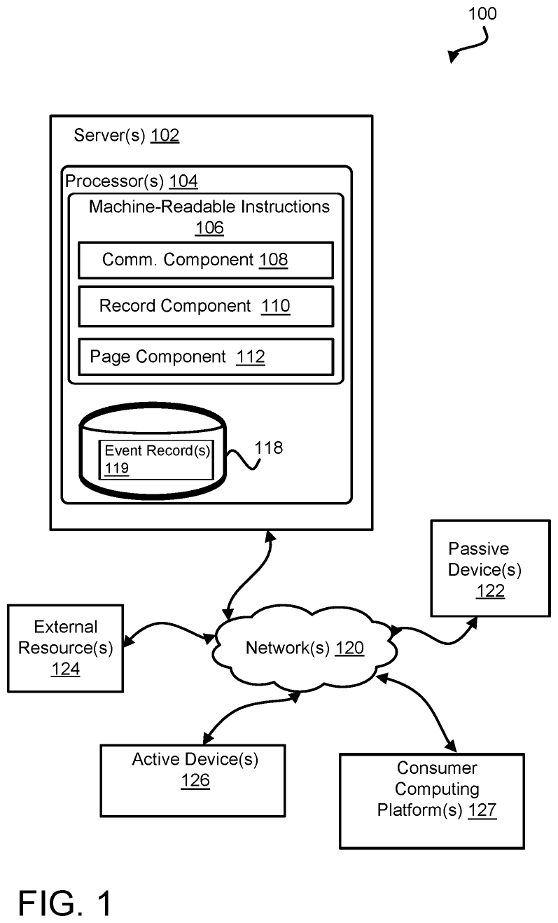

FIG. 1 illustrates a system 100 configured to track assets using active devices and passive devices, in accordance with one or more implementations. Traditional tracking systems may only provide location updates at discrete points in time and/or in connection with discrete locations. These traditional tracking systems do not provide live, real-time or near-real time, tracking of the actual locations of the assets. One or more implementations of the system 100 presented herein may track assets using passive and active devices by handing off the tracking functionality between devices when a passive device is read by an active device. A passive device may be included with and/or coupled to an asset and may be used to identify the asset as well as provide location updates at discrete points in time and/or in connection with discrete locations. An active device may provide relatively more robust location information closely tied to live, real-time or near-real time, tracking of the actual location of the asset. By way of non-limiting illustration, an active device may comprise a device that is configured for relatively higher location sampling rate compared to a passive device.

The system 100 may include one or more of one or more servers 102, one or more passive devices 122, one or more active devices 126, one or more consumer computing platforms 127, and/or other components.

Individual passive devices may include electronic components and/or other physical components that may not require an external power source to function. By way of non-limiting illustration, a passive device may include one or more of a passive radio-frequency identification (RFID) device (or tag), a barcode (e.g., a matrix barcode such as a QR code, a linear barcode such as UPC barcode, and/or other barcodes), and/or other components. Individual passive devices may be included with, affixed to, and/or otherwise associated with an asset to be tracked.

Individual active devices may comprise electronic circuitry and/or other components that may rely on an external power source to control or modify electrical signals. By way of non-limiting illustration, an active device may include a computing platform. A computing platform may include one or more of a power source (e.g., a battery), processor(s), one or more transceivers to wirelessly communicate information with a network, and/or other components. By way of non-limiting illustration, an individual active device may include one or more of a client computing platform, a reader device (e.g., RFID reader, barcode scanner, and/or other devices), a standalone global positioning system (GPS) unit, an active RFID device, and/or other devices.

A client computing platform may include one or more of a mobile computing platform (e.g., one or more of a cellular telephone, a smartphone, a laptop, a tablet computer, and/or other mobile platforms), a stationary computing platform (e.g., a desktop computer), and/or other computing platforms.

A reader device may include a standalone computing platform specifically configured to reach one or more passive devices. By way of non-limiting illustration, a reader device may include one or more of a barcode scanner, an RFID reader, and/or other devices. A reader device may be configured to detect and/or read barcodes, decode the information contained in the barcode, and/or perform other functionality. A reader device may include one or more of a light source, a lens, a sensor component configured to translate optical impulses into electrical signals, decoder circuitry configured to analyze a barcode's image data provided by a sensor, and/or other components.

Individual active devices of one or more active devices 126 may include devices through which users participate in tracking of an asset. The users who participate in the tracking of an asset via an individual active device may include one or more of a delivery person, mail carrier, and/or other personnel under a duty or responsibility to transport assets.

Individual consumer computing platforms of one or more consumer computing platforms 127 may include devices through which consumers access system 100. Consumers may refer to users who participate in system 100 to monitor the tracking of an asset. An individual consumer computing platform may include one or more of a cellular telephone, a smartphone, a laptop, a tablet computer, a virtual reality platform, a game console, a camera, a desktop computer, a mixed reality headset, augmented reality device, and/or other consumer computing platform. In some implementations, an individual consumer computing platform may include one or more of one or more processors, a display, one or more sensors, and/or other components. A display may be configured to present visual content. The visual content may include one or more of individual images, image sequences, video, text, and/or other content. Presentation via a display of a consumer computing platform may be facilitated by one or more processors of the consumer computing platform and/or other components. By way of non-limiting example, presentation may be facilitated by a graphics processing unit (GPU) and/or other components. A display may include one or more of a screen, a touchscreen, a monitor, a head-mounted display, a set of screens, and/or other displays.

The one or more servers 102 may include one or more of one or more physical processors 104, non-transitory electronic storage 118, and/or other components. The non-transitory electronic storage 118 may be configured to store information utilized by one or more servers 102, one or more passive devices 122, one or more active devices 126, one or more consumer computing platforms 127, and/or other components of system 100.

In some implementations, one or more servers 102 may be configured to provide remote hosting of features and/or functions of machine-readable instructions 106 to one or more of one or more active devices 126, one or more consumer computing platforms 127, and/or other components. The one or more passive devices 122, one or more active devices 126, one or more consumer computing platforms 127, and/or other components may be remotely located from one or more servers 102. The one or more servers 102 may communicate with the one or more passive devices 122, one or more active devices 126, one or more consumer computing platforms 127, and/or other components via client/server architecture, and/or other communication schemes. In some implementations, individual active devices may download an application (e.g., non-transitory electronically stored information) configured to provide access to features and/or functions of machine-readable instructions 106. In some implementations, individual consumer computing platforms may download an application (e.g., non-transitory electronically stored information) configured to provide access to features and/or functions of machine-readable instructions 106.

In some implementations, one or more features and/or functions of one or more servers 102 may be attributed as local features and/or functions of individual ones of the one or more active devices 126 and/or one or more consumer computing platforms 127. For example, individual active devices and/or individual consumer computing platforms may obtain and/or include machine-readable instructions that may be the same or similar to machine-readable instructions 106 of one or more physical processors 104.

In some implementations, an individual passive device may be configured to store and/or communicate information to one or more active devices 126. By way of non-limiting illustration, a passive RFID may be configured to store and/or transit radio signals carrying information. By way of non-limiting illustration, a barcode may be configured to store and/or convey information when read. The information may include identification information and/or other information. The identification information may include one or more information that identifies a passive device (e.g., make, model, serial number, manufacturer, unique ID, and/or other information), information that identifies an asset carrying the passive device (e.g., make, model, serial number, manufacture, unique ID, and/or other information), information that identifies a consumer associated with the asset (e.g., name, username, and/or other identifying information about a consumer who purchases and/or is otherwise associated with the asset), and/or other information.

Individual active devices may include devices configured to present and/or generate content. Content may include visual and/or audio content. An individual active device may include one or more of a display, one or more sensors, one or more transceivers, and/or other components. A display may be configured to present visual content. The visual content may include one or more of individual images, image sequences, video, text, and/or other content. Presentation via a display may be facilitated by one or more processors of the active device and/or other components. By way of non-limiting example, presentation may be facilitated by a graphics processing unit (GPU) and/or other components. A display may include one or more of a screen, a touchscreen, a monitor, a head-mounted display, a set of screens, and/or other displays.

In some implementations, one or more sensors of an individual active device may be one or more of an image sensor, an audio sensor, one or more optical sensors, a location sensor, a radio-frequency reader and/or writer, and/or other sensors.

An image sensor may be configured to generate output signals conveying image information and/or other information. In some implementations, image information may define one or more of an image, an image sequence, a video, and/or other representations of the real-world space. An image may be defined by a set of pixels and/or other information. Individual pixels in the set of pixels may be defined by one or more of a pixel location, a pixel color, and/or other specifications. A pixel location may include a location on an image plane. Pixel color may be defined by chromaticity of colors specified within a color space, such as an RGB color space. An image sensor may include one or more of a charge-coupled device sensor, an active pixel sensor, a complementary metal-oxide semiconductor sensor, an N-type metal-oxide-semiconductor sensor, and/or other devices.

An audio sensor may generate output signals conveying audio information and/or other information. The audio information may define voice and/or sounds captured by the audio sensor. An audio sensor may include a microphone.

A location sensor may be configured to generate output signals conveying location information and/or other information. Location information derived from output signals of a location sensor may define one or more of a geo-location, an elevation, a planned route, and/or other measurements. A location sensor may include one or more of a GPS, an altimeter, a navigation system, and/or other devices.

An optical sensor may be configured to detect and/or read optical impulses and/or analyze image data provided by the optical sensor.

A radio-frequency reader and/or writer may be configured for wireless radio frequency (RF) communications. For example, a reader and/or writer may be configured for wireless Bluetooth communications, near field communications (NFC), radio frequency identification (RFID) tag communications, and/or other communications. Reader and/or writer may comprise a radio frequency identification (RFID) tag reader and/or writer. A reader may comprise one or more components of a passive reader active tag (PRAT) system, active reader passive tag (ARPT) system, active reader active tag (ARAT) system, and/or other considerations of components which may receive RF signals. In some implementations, a writer may comprise one or more components that are configured to send (e.g., write) RF signals. In some implementations, a reader and/or writer may be provided as a single component, such as a combined RFID tag reader/writer, configured for both sending and receiving RF signals.

Individual active devices may be configured to obtain and/or generate information relating to individual passive devices based on output signals of the one or more sensors and/or other sources of information. By way of non-limiting illustration, an individual active device may be configured to generate one or more of detection information, identification information, location information, image information, and/or other information.

In some implementations, individual active devices may be configured to detect presence of individual passive devices of one or more passive devices 122 to generate detection information. The detection information may convey that a detection has occurred. In some implementations, detecting presence of a passive device may be based on one or more of an image-based technique (e.g., computer vision), obtaining one or more radio signals communicated from a passive device, and/or other techniques.

In some implementations, the individual active devices may be configured to obtain image information derived from output signals generated by an individual image sensor included in an individual active device. The detection of presence of one or more passive devices 122 based on image information may be accomplished through one or more image-processing techniques. By way of non-limiting illustration, techniques may include one or more of computer vision, Speeded Up Robust Features (SURF), Scale-invariant Feature Transform (SIFT), Oriented FAST and rotated BRIEF (ORB), and/or other techniques.

Responsive to the detection of presence of a passive device, an individual active device may be configured to generate and/or obtain information related to a passive device. The information related to a passive device may include one or more of identification information, location information, image information, and/or other information related to a passive device. The identification information may identify the individual passive devices having been detected. In some implementations, the identification information may be conveyed to the individual active device from the individual passive device. In some implementations, location information for an individual passive device may be a location of the individual active device at the time of detection by the individual active device. In some implementations, image information may define one or more of an image, an image sequence, a video, and/or other representations of a real-world space. By way of non-limiting illustration, the image information may include an image of a passive device (and/or asset) taken by an active device. In some implementations, the image depicting the location of a passive device (and/or asset) may be stored in combination with the location of the active device that took the image. That is, the image of the passive device (and/or asset) may be geo-tagged with the location of the active device that took the image. Accordingly, the image may convey a geo-tagged image of the passive device (and/or asset).

In some implementations, an individual active device may be configured to compile the information relating to individual passive devices into passive report information. By way of non-limiting illustration, the passive report information for an individual passive device may convey one or more of detection of individual passive device, identification of the individual passive device, location of the individual passive device, a geo-tagged image of the passive device, and/or other information.

In some implementations, an individual active device may be configured to store and/or obtain information relating to the individual active device itself. The information stored and/or obtained relating the individual active device may include device identification information, device location information, image information, and/or other information.

Device identification information may include one or more information that identifies an active device (e.g., make, model, serial number, manufacturer, unique ID, and/or other information), information that identifies a user associated with the active device (e.g., name, username, and/or other identifying information about a user), and/or other information

Device location information may include location of an individual active device. The device location information for an individual active device may be derived from output signals of a location sensor and/or other sensors.

In some implementations, the image information in the active report information may include an image of a real-world environment taken by an active device. By way of non-limiting illustration, the image may depict the location of the individual active device (e.g., an image of a front doorstep of a delivery address). In some implementations, the image depicting the location of the individual active device may be stored in combination with the location derived from a location sensor. That is, the image may be geo-tagged with the location.

In some implementations, an individual active device may be configured to compile the information relating to the individual active device itself into active report information. By way of non-limiting illustration, the active report information for an individual active device may convey one or more of identification of the individual active device, location of the individual active device, image information, and/or other information.

In some implementations, an individual active device may be configured to compile information relating to the individual active device itself into active report information in response to the individual active device coming into a predefined geofence. By way of non-limiting illustration, a location, such as a destination of the asset (and/or waypoint), may be associated with a predefined geofence. The location may comprise a center of the geofence and/or other reference point.

In FIG. 1, one or more physical processors 104 of server(s) 102 may be configured by machine-readable instructions 106. Executing machine-readable instructions 106 may cause one or more physical processors 104 to facilitate tracking assets using active devices and passive devices. The machine-readable instructions 106 may include one or more computer program components. The one or more computer program components may include one or more of a communication component 108 (abbreviated “Comm. Component 108” in FIG. 1), a record component 110, a page component 112, and/or other components.

The communication component 108 may be configured to obtain information relating to one or more of one or more passive devices 122, one or more active devices 126, and/or other entities of system 100. The communication component 108 may be configured to obtain information from one or more active devices 126, one or more consumer computing platforms 127, and/or other entities over network(s) 120, such as the Internet and/or other networks.

The communication component 108 may be configured to obtain passive report information for one or more passive devices 122 and/or other information. The passive report information may convey one or more of detection of the one or more passive devices 122, identification of the one or more passive devices 122, location of the one or more passive devices 122, image information, and/or other information.

The passive report information may be obtained by communication component 108 from individual active devices of one or more active devices 126. The passive report information for an individual passive device may be generated by an individual active device in response to the detection of the individual passive device by the individual active device. The individual active device may be configured to effectuate communication of passive report information to communication component 108 over a wireless communications network (e.g., network(s) 120) in response to generating the passive report information. In some implementations, communication component 108 may be configured to retrieve the passive report information from the individual active devices. In some implementations, communication component 108 may be configured to send requests to the individual active devices to retrieve the passive report information from the individual active devices. In some implementations, the requests may be sent periodically.

The communication component 108 may be configured to obtain active report information for one or more active devices 126 and/or other information. The active report information may convey one or more of identification of the one or more active devices 126, location of the one or more active devices 126, image information, and/or other information.

The active report information may be obtained by communication component 108 from individual active devices. The active report information for an individual active device may be generated by an individual active device in response to the detection of an individual passive device by the individual active device. In some implementations, the active report information for an individual active device may be generated by an individual active device in response to the individual active device coming into a predefined geofence. The individual active device may be configured to effectuate communication of active report information to communication component 108 over a wireless communications network (e.g., network(s) 120) in response to generating the active report information. In some implementations, communication component 108 may be configured to retrieve the active report information from the individual active devices. In some implementations, communication component 108 may be configured to send requests to the individual active devices to retrieve the active report information from the individual active devices. In some implementations, the requests may be sent periodically.

In some implementations, an individual active device may be configured to obtain device location information conveying current location of the individual active device in a recurring manner. A recurring manner may be a predetermined frequency, based on a sampling rate, and/or other rate. By way of non-limiting illustration, the predetermined frequency may be once every minute, once every hour, once every half hour, once a day, and/or other frequencies.

In some implementations, the generation of active report information may be indicative of a handoff of tracking functionality to an active device. Thus, obtaining the location information conveying current location in a recurring manner may provide live, real-time or near real-time updates as to an actual location of the active device (which also represents location of a passive device and/or asset carrying the passive device).

The individual active device may be configured to effectuate communication of the device location information conveying current location to communication component 108 over a wireless communications network (e.g., network(s) 120) in response to the recurring obtainment of the device location information. The communication of the device location information conveying current location may create “breadcrumbs” as to the location of the active device representing location of the passive device and/or asset. The recurring obtainment of the device location information may occur until an ending point in time. In some implementations, the ending point in time may be when an individual passive device is detected again by the individual active device and/or by one or more other active devices. This end point in time may be indicative of handing off the tracking functionality to another active device and/or to the individual passive device. In some implementations, the end point in time may be based on a threshold passage of time. In some implementations, the ending point in time may be when the individual active device comes within a predefined geofence.

By way of non-limiting illustration, first passive report information for a first passive device may be generated by a first active device in response to a detection of a first passive device by first active device. The first active device may include one or more sensors configured to generate output signals. The first active device may be configured to generate the first passive report information by detecting the first passive device based on the output signals of the one or more sensors, identifying the first passive device, determining a first location of the first passive device based on the output signals of the one or more sensors, and/or performing other operations. The first active device may be configured to effectuate communication of the first passive report information to the server(s) 102 over network(s) 120 in response to generating the first passive report information.

By way of non-limiting illustration, first active report information for the first active device may be generated by the first active device in response to the detection of the first passive device by the first active device. The first active device may be configured to generate the first active report information by, in response to the detection of the first passive device by the first active device, obtaining identification information conveying the identification of the first active device, obtaining location information conveying the second location of the first active device, and/or performing other operations. The first active device may be configured to effectuate communication of the first active report information to the server(s) 102 over network(s) 120 in response to generating the first active report information.

In some implementations, the first active device may be configured to, in a recurring manner until the first passive device is detected by a second active device, obtain the device location information conveying current location of the first active device. The first active device may be configured to effectuate communication of the device location information to the server(s) 102 over network(s) 120 as the device location information is obtained in the recurring manner.

The record component 110 may be configured to generate one or more event records 119. The one or more event records 119 may be stored in electronic storage 118 and/or other storage locations. The one or more event records 119 may be generated based on information obtained by communication component 108, and/or other information. The record component 110 may be configured to generate one or more event records 119 based on one or more of the passive report information, the active report information, and/or other information. The one or more event records 119 may be indicative of physical movement of one or more assets carrying the one or more passive devices. By way of non-limiting illustration, the one or more event records 119 may include one or more passive reporting event records, one or more active reporting event records, and/or other records.

An individual passive reporting event record may be generated in response to the passive report information for an individual passive device being obtained and/or in response to other triggers. The individual passive reporting event record may include one or more of indication of the detection of an individual passive device, identification of the individual passive device, location of the individual passive device, a timestamp when the passive report information was generated and/or obtained, and/or other information. By way of non-limiting illustration, a first passive reporting event record may be generated in response to communication component 108 obtaining the first passive report information for the first passive device. The first passive reporting event record may include one or more of an identification of the first passive device, a first location of the first passive device, and/or other information.

An individual active reporting event record may be generated in response to the active report information for an individual active device being obtained and/or in response to other triggers. The individual active reporting event record may include one or more of an identification of the individual active device, location of the individual active device, a timestamp when the active report information was generated and/or obtained, and/or other information. By way of non-limiting illustration, a first active reporting event may be generated in response to communication component 108 obtaining the first active report information for the first active device. The first active reporting event record may include one or more of an identification of the first active device, location of the first active device, and/or other information.

In some implementations, the record component 110 may be configured to organize the one or more event records 119 to generate a series of event records. The series of event records may organize multiple event records in chronological order with respect to when the active report information and the passive report information are obtained. Accordingly, the series of event records may convey a timeline of physical movement of one or more assets carrying the one or more passive devices.

The page component 112 may be configured to generate individual pages for the individual series of event records. The page component 112 may be configured to generate individual pages for the individual series of event records in response to a temporally first event record in a series of event records being generated. By way of non-limiting illustration, a temporally first detection of a passive device may initiate creating a page tagged with an ID of the passive device. The individual pages may facilitate access to the individual series of event records so that the physical movement of one or more assets may be tracked, monitored. and/or otherwise maintained. The individual pages may be accessed via links (e.g., embedded URLs), and/or other types of access. An individual page may be associated with a series of event records related to tracking one or more assets via one or more passive devices and one or more active devices. An individual page may include and/or be associated with an identification of an asset and/or passive device. The individual pages may include web pages and/or other remotely accessible information (e.g., shared documents etc.).

Individual pages may be stored in electronic storage 118 and/or other storage locations. The individual pages may be associated with addresses (e.g., network addresses) where assets defining the individual pages are located within storage 118.

A page may include an integrated set of content, which may include a series of event records for a given tracking event for an asset, information that describes the type or nature of the asset and/or tracking that is related to the asset, and/or other information. Information related to the asset and/or tracking that is related to the asset include information about the sender of the asset, the origin of the asset, entities involved in the physical movement of the asset (e.g., delivery company, company managing a warehouse, etc.), and/or other information that may be pre-stored in the system 100 or information currently learned from a particular tracking event. The individual page may be updated dynamically and/or continuously as event records are generated.

In some implementations, individual pages may include scrollable user interfaces. A page may include a vertical arrangement of the event records which may be scrolled through to view different portions of the service of event records. Scrolling may be accomplished through user input, for example, finger swiping a touchscreen display of a computing platform.

The page component 112 may be configured to effectuate presentation of a user interface on individual consumer computing platforms of one or more consumer computing platforms 127. Effectuating presentation may include sending control signals and/or other signals and/or commands to the individual consumer computing platforms to cause the individual consumer computing platforms to present a user interface. An instance of the user interface may be configured to display a page for a series of event records.

In some implementations, page component 112 may be configured to retrieve a template that serves as a basis for creating a page. The template may be configured by a user in order to customize a page that is created based on the template. The template may include default information to include (or exclude). In some implementations, templates may have at least some information or elements that are common to each template. In some implementations, different templates may be created and used for different communication channels. For example, a page that is to be shared via a broadband communication channel (e.g., high-speed Internet) may be formatted differently than a page that is to be shared via Short Message Service (“SMS”) text. For example, a page shared over SMS text may include less detail and content than a page shared over the Internet. In some implementations, page component 112 may be configured to generate different versions of the page based on the communication channel over which the page is to be communicated. In some implementations, the communication channel over which the page is to be communicated may be determined based on the type, configuration, and/or capabilities of the individual consumer computing platform which is accessing the page.

In some implementations, page component 112 may identify a recipient computing platform that should receive a page based on input from another user, a time, a location of the recipient, a user profile for the recipient, and/or other information used to identify recipients. In some implementations, page component 112 may identify a recipient of a page based on user input. For example, page component 112 may receive an identification of a user with whom the page should be shared. The identification may be received from the user who requested to access the page and/or other users. In some implementations, page component 112 may identify one or more communication channels over which the page is capable of being communicated based on the recipient computing platform.

In some implementations, the page component 112 may be configured to monitor user engagement with the individual pages. User engagement may include one or more of time-spent viewing a page, amount and/or direction of scrolling, and/or other information. The page component 112 may be configured to effectuate changes to the individual pages in response to the user engagement. Changes may include one or more of adding content to the individual pages that was previously not on the pages, removing content from the individual pages, replacing content of the individual pages with other content that was previously not on the pages, and/or other changes.

In some implementations, the page component 112 may be configured to create and/or manage workflows by providing integrated workflow tools with the pages. The page component 112 may allow users to view and/or update a current tracking status assocaited with a page. The page component 112 may automatically update a current tracking status assocaited with a page based on the updates of the content on the page itself. For example and without limitation, a tracking status may include “page created,” “asset picked up,” “first event record created,” “second event record created,” “driver within a predefined geofence,” and/or “asset delivered” to indicate the general status of a tracking event.

In some embodiments, page component 112 may provide various workflow tools. A user may interface with the workflow tools to update the tracking status, manage next steps that should be performed (e.g., send communication(s)), and/or perform other tasks related to a tracking event. A user may use the workflow tools to input a status such as “asset is picked up”, a current location, an estimated distance to destination, an estimated time to the destination, and/or other information. However, in some implementations, the status may be automatically updated by monitoring the change the content of the pages. The workflow tools may be used to specify other actions to be carried out in response to the current tracking status.

In some implementations, the page component 112 may be configured to send out a communication/notification independent from a page (e.g., via an email to a contact's email address, a text message to a phone number, and/or other communication) in response to changes in a current tracking status and/or in response to certain content being included in the page after an update. In some implementations, page component 112 may be configured to notify various users with whom the page has been shared of the creation, update, expiration, and/or other status updates related to the page. By way of non-limiting illustration, a given tracking status may comprise a trigger to perform an action of sending a communication independent from a page. By way of non-limiting illustration, a certain information being included in a page after an update may comprise a trigger to perform an action of sending a communication independent from a page.

In some implementations, page component 112 may cause a notification that a shared page has been updated to be provided to one or more recipients. A messaging service (e.g., SMS text message, email, social media platform, etc.) may be used to convey the notifications/communications. By way of non-limiting illustration, a current tracking status of “arrived within a geofence at time X” may trigger the sending of a notification to a user of a potential delay in delivery time (or delivery being ahead of schedule).

In some implementations, a communication independent from a page may include instructions to carry out one or more actions. The communication including instructions to carry out one or more actions may be communicated to a user and/or an other computer system. A communication including instructions to carry out one or more actions may be sent to a computer system specifically configured to carry out the one or more actions. By way of non-limiting illustration, a current tracking status of “delivered” may trigger the sending of a communication to a computing platform running billing software, where the communication may include instructions to generate and send out an invoice (e.g., the invoice being related to the delivery, now having the status of “delivered” and is thereby ready to bill). Other actions are contemplated.

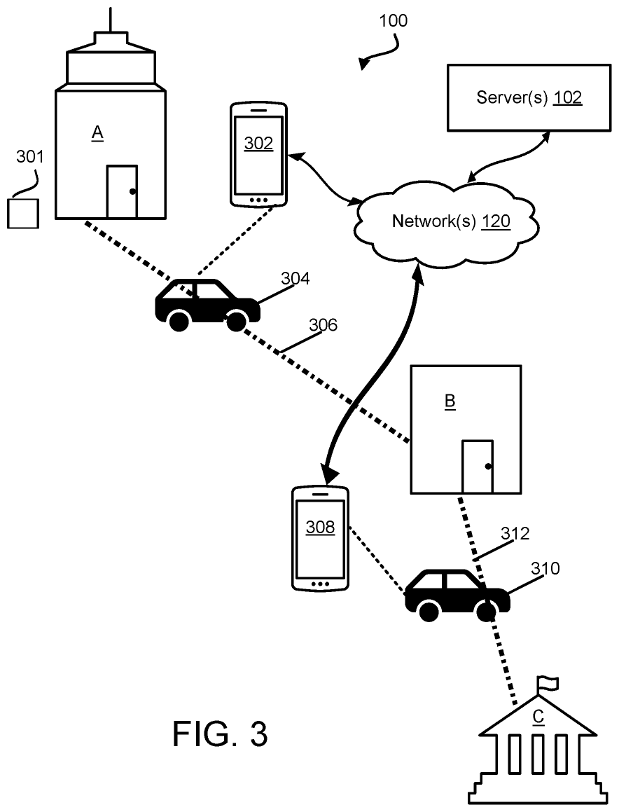

FIG. 3 illustrates an implementation of the system 100 of FIG. 1 configured to track assets using active devices and passive devices. For illustrative purposes, the tracking of an asset 301 from location A to location B, and from location B to location C is shown. Location A may represent a departure location, such as a manufacturer. Location B may represent a waypoint in the transportation, such as transfer warehouse. Location C may represent a destination. At location A, the asset 301 carrying a passive device may be read by a first active device 302. The first active device 302 may generate and/or obtain first passive report information. The first passive report information may be communicated to server(s) 102 over network(s) 120. Server(s) 102 may generate a first passive reporting event record. The first passive reporting event record may convey a first discrete location update of the asset 301 at location A. In response to reading the passive device of the asset 301, the first active device 302 may generate and/or obtain first active report information, thereby handing off tracking to the first active device 302. The first active report information may be communicated to server(s) 102 over network(s) 120. Server(s) 102 may generate a first active reporting event record. The first active reporting event record may convey the handoff of tracking to the first active device 302. The first active device 302 may be carried by a user transporting asset 301 in a vehicle 304 along route 306. The first active device 302 may generate device location information in a recurring manner while along route 306 to provide live, real-time or near real-time location of the asset 301. The recurring device location information may continuously and/or dynamically update the first active reporting event record.

The first active device 302 may generate the device location information in the recurring manner until the passive device of the asset 301 is read by a second active device (not shown) at location B. The second active device at location B may generate and/or obtain second passive report information in response to reading the passive device of the asset 301. The second passive report information may be communicated to server(s) 102 over network(s) 120. Server(s) 102 may generate a second passive reporting event record. The second passive reporting event record may convey a second discrete location update of the asset 30 at location B.

In response to reading the passive device of the asset 301 and/or the second passive reporting event record being generated, the second active device at location B may generate and/or obtain second active report information. The second active report information may be communicated to server(s) 102 over network(s) 120. Server(s) 102 may generate a second active reporting event record. The second active reporting event record may convey a handoff of tracking to the second active device. The second active device may comprise, for example, a reader device that tracks the movement of the asset 301 within location B. The sampling of location by second active device may be less than first active device 302 because the asset 301 may be infrequently moving locations within location B.

At location B, the asset 301 carrying the passive device may be read by a third active device 308. The third active device 308 may generate and/or obtain third passive report information. The third passive report information may be communicated to server(s) 102 over network(s) 120. Server(s) 102 may generate a third passive reporting event record. The third passive reporting event record may convey a third discrete location update of the asset 301 at location B (e.g., at a dock). In response to reading the passive device of the asset 301, the third active device 308 may generate and/or obtain third active report information. The third active report information may be communicated to server(s) 102 over network(s) 120. Server(s) 102 may generate a third active reporting event record. The third active reporting event record may convey a handoff of tracking to the third active device 308. The third active device 308 may be carried by a user transporting asset 301 in a vehicle 310 along route 312. The third active device 308 may generate device location information in a recurring manner while along route 312 to provide live, real-time or near real-time location as to the asset 301. The recurring device location information may continuously and/or dynamically update the third active reporting event.

The third active device 308 may generate the device location information in the recurring manner until the passive device of the asset 301 is read by the third active device 308 and/or other device at location C. The third active device 308 at location C may generate and/or obtain third passive report information. The third passive report information may be communicated to server(s) 102 over network(s) 120. Server(s) 102 may generate a third passive reporting event record. The third passive reporting event record may convey a third discrete location update of the asset 30 at location C. In some implementations, the third passive report information may include a geo-tagged image of the asset 301 taken at location C.

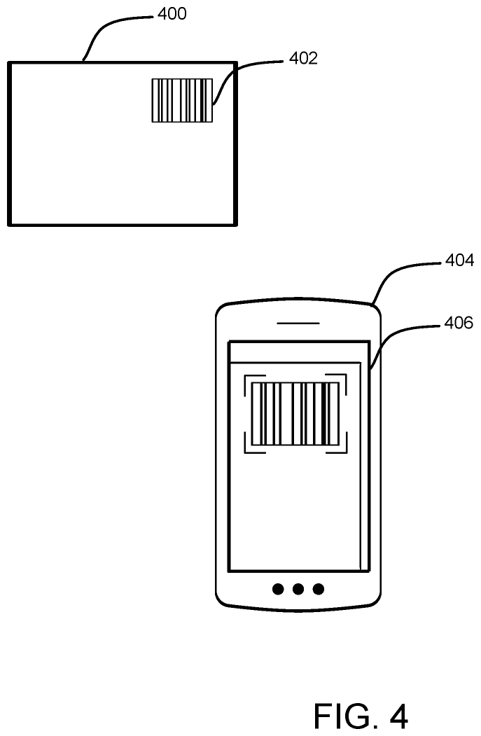

FIG. 4 illustrates an active device 404 and a user interface 406 in accordance with one or more implementations. The active device 404 may be configured to detect a passive device 402 carried by an asset 400. The active device 404 may include one or more sensors configured to detect and/or obtain information from passive device 402. By way of non-limiting illustration, the passive device 402 may include a barcode. The active device 404 may be configured to read the barcode, as presented on the user interface 406 of the active device 404. In some implementations, for different types of passive devices (e.g., RFID), the user interface 406 may include one or more selectable user interface elements which cause active device 404 to change functionality to detect the different types of passive devices. By way of non-limiting illustration, if passive device 402 was instead an RFID tag, user interface 406 may present options to perform functionality of sending and/or receive RF signals to detect and/or obtain information from the RFID tag.

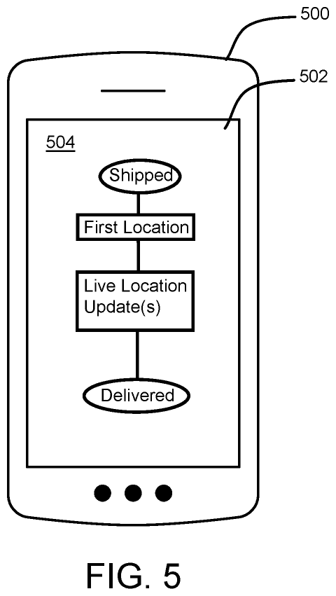

FIG. 5 illustrates a user interface 502 displaying a page 504, in accordance with one or more implementations. The user interface 502 may be presented on a consumer computing platform 500. The page 504 may include an integrated set of content, which may include a series of event records for a given tracking event for an asset. By way of non-limiting illustration, the series of event records may include a timeline of location updates, both discrete and live, real-time or near real-time, location. In some implementations, selection of live, real-time or near real-time location may cause the user interface 502 to display an interactive map and/or other display which conveys live, real-time or near real-time, location. The interactive map may include a series of “breadcrumbs” showing the location of the asset over time.

It is noted that the examples shown and described with respect to FIG. 3-FIG. 5 are for illustrative purposes only and not to be considered limiting. Instead, those skilled in the art may appreciate other use cases involving the features and/or functionality described herein. By way of non-limiting illustration of another use case, consider an asset being delivered to a house (address). A delivery person having a smartphone may read a barcode on the asset and communicate the location and identification of the asset to a server. The server may generate an event record as a part of a set of event records accessible via a page, and communicate the page to a consumer. This may become a geo-tagged time stamped document of the asset being out for delivery. The system may identify the intended delivery address, and create a geofence around that address. The delivery person's smartphone may then generate its own GPS location information along with timestamps. This information may be recorded in the set of event records accessible via the page. When the smartphone comes within the geofence, the page may be updated to reflect the asset is delivered. This may provide a geo-tagged timestamped documentation of delivery.

In yet another illustrative example, a first detection of a passive device may initiate creating a page tagged with an ID of the passive device. This may be considered the start of a process such as when an asset was picked up at a warehouse. Subsequent detections of the passive device may be tagged with location and added to the same Page to create a breadcrumb of reads with time and location. The last detection may be coming within a geofence. The last detection may cause the process to close (e.g., stop updating the page) to indicate delivery of the asset.

Returning to FIG. 1, server(s) 102, one or more passive devices 122, one or more active devices 126, one or more consumer computing platforms 127, external resource(s) 124, and/or other components may be operatively linked via one or more electronic communication links. For example, such electronic communication links may be established, at least in part, via one or more networks 120. One or more networks 120 may include the Internet, Bluetooth, Near field communication, and/or other networks. It will be appreciated that this is not intended to be limiting and that the scope of this disclosure includes implementations in which components of system 100 may be operatively linked via some other communication media.

External resource(s) 124 may include sources of information, hosts, and/or providers of information outside of system 100, external entities participating with system 100, and/or other resources. In some implementations, some or all of the functionality attributed herein to external resource(s) 124 may be provided by resources included in system 100.

Server(s) 102 may include communication lines or ports to enable the exchange of information with one or more of a network, passive device(s) 122, active device(s) 126, consumer computing platform(s) 127, and/or other components. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 118 may include electronic storage media that electronically stores information. The electronic storage media of electronic storage 118 may include one or both of system storage that is provided integrally (i.e., substantially non-removable) with server(s) 102 and/or removable storage that is removably connectable to server(s) 102 via, for example, a port or a drive. A port may include a USB port, a firewire port, and/or other port. A drive may include a disk drive and/or other drive. Electronic storage 118 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 118 may include one or more virtual storage resources (e.g., cloud storage, a virtual private network, and/or other virtual storage resources). Electronic storage 118 may store software algorithms, information determined by processor(s) 104, information received from computing platform(s) 122, and/or other information that enables system 100 to function as described herein.

Processor(s) 104 may be configured to provide information-processing capabilities in server(s) 102. As such, processor(s) 104 may include one or more of a digital processor, an analog processor, a digital circuit designed to process information, an analog circuit designed to process information, a state machine, and/or other mechanisms for electronically processing information. Although processor(s) 104 is shown in FIG. 1 as a single entity, this is for illustrative purposes only. In some implementations, processor(s) 104 may include one or more processing units. These processing units may be physically located within the same device, or processor(s) 104 may represent processing functionality of a plurality of devices operating in coordination. The processor(s) 104 may be configured to execute components 108, 110, and/or 112. Processor(s) 104 may be configured to execute components 108, 110, and/or 112 by software; hardware; firmware; some combination of software, hardware, and/or firmware; and/or other mechanisms for configuring processing capabilities on processor(s) 104.

It should be appreciated that although components 108, 110, and/or 112 are illustrated in FIG. 1 as being co-located within a single processing unit, in implementations in which processor(s) 104 includes multiple processing units, one or more of components 108, 110, and/or 112 may be located remotely from the other components. While computer program components are described herein as being implemented via processor(s) 104 through machine readable instructions 106, this is merely for ease of reference and is not meant to be limiting. In some implementations, one or more functions of computer program components described herein may be implemented via hardware (e.g., dedicated chip, field-programmable gate array). One or more functions of computer program components described herein may be one or more of software-implemented, hardware-implemented, and/or software and hardware-implemented. The description of the functionality provided by the different components 108, 110, and/or 112 described above is for illustrative purposes and is not intended to be limiting, as any of components 108, 110, and/or 112 may provide more or less functionality than is described. For example, one or more of components 108, 110, and/or 112 may be eliminated, and some or all of its functionality may be provided by other ones of components 108, 110, 112, and/or other components. As another example, processor(s) 104 may be configured to execute one or more additional components that may perform some or all of the functionality attributed to one of components 108, 110, and/or 112.

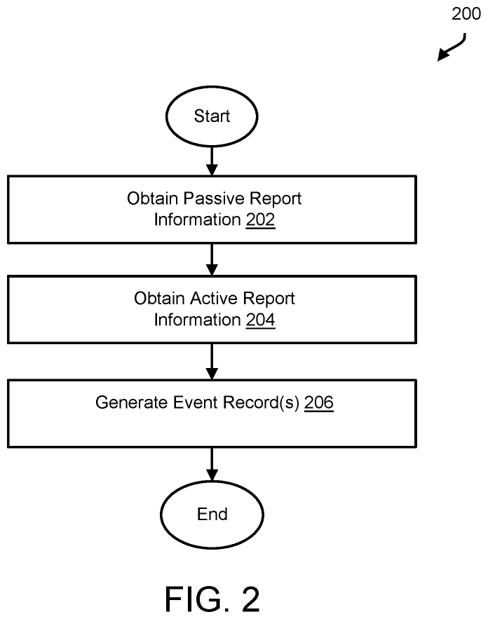

FIG. 2 illustrates a method 200 to track assets using active devices and passive devices. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in a system comprising one or more processing devices (e.g., a digital processor, physical processor, an analog processor, a digital circuit designed to process information, an analog circuit designed to process information, a state machine, and/or other mechanisms for electronically processing information), storage media storing machine-readable instructions, one or more active devices, one or more passive devices, one or more consumer computing platforms, and/or other components. The one or more processing devices may include one or more devices executing some or all of the operations of method 200 in response to instructions stored electronically on electronic storage media. The one or more processing devices may include one or more devices configured through hardware, firmware, and/or software to be specifically designed for execution of one or more of the operations of method 200.

At an operation 202, passive report information for one or more passive devices may be obtained. The passive report information may convey one or more of detection of the one or more passive devices, identification of the one or more passive devices, location of the one or more passive devices, and/or other information. In some implementations, operation 202 may be performed by one or more physical processors executing a component the same as or similar to communication component 108 (shown in FIG. 1 and described herein).

At an operation 204, active report information for one or more active devices may be obtained. The active report information may convey one or more of identification of the one or more active devices, location of the one or more active devices, and/or other information. In some implementations, operation 204 may be performed by one or more physical processors executing a component the same as or similar to communication component 108 (shown in FIG. 1 and described herein).

At an operation 206, one or more event records may be generated based on one or more of the passive report information, the active report information, and/or other information. The events records may be indicative of physical movement of one or more assets carrying the one or more passive devices. The event records may include passive reporting event records, active reporting event records, and/or other records. An individual passive reporting event record may be generated in response to the passive report information for an individual passive device being obtained. The individual passive reporting event record may include at least the identification and the location of the individual passive device. An individual active reporting event record may be generated in response to the active report information for an individual active device being obtained. The individual active reporting event record may include at least the identification and the location of the individual active device. In some implementations, operation 206 may be performed by one or more physical processors executing a component the same as or similar to record component 110 (shown in FIG. 1 and described herein).

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured to track assets using active devices and passive devices, the system comprising:
one or more physical processors configured by machine-readable instructions to:
obtain passive report information for one or more passive devices, the passive report information conveying detection of the one or more passive devices, identification of the one or more passive devices, and location of the one or more passive devices;
obtain active report information for one or more active devices, the active report information conveying identification of the one or more active devices and location of the one or more active devices; and
generate event records based on the passive report information and the active report information, the events records being indicative of physical movement of one or more assets carrying the one or more passive devices, the event records including:
passive reporting event records, an individual passive reporting event record being generated in response to the passive report information for an individual passive device being obtained, wherein the individual passive reporting event record includes at least the identification and the location of the individual passive device, such that a first passive reporting event record is generated in response to obtaining first passive report information for a first passive device, the first passive reporting event record including an identification of the first passive device and a first location of the first passive device;
active reporting event records, an individual active reporting event record being generated in response to the active report information for an individual active device being obtained, wherein the individual active reporting event record includes at least the identification and the location of the individual active device, such that a first active reporting event is generated in response to obtaining first active report information for a first active device, the first active reporting event record including an identification of the first active device and a second location of the first active device; and
wherein the event records are organized to generate a series of the event records, wherein the series organizes the event records in chronological order with respect to the active report information and the passive report information being obtained, such that the series of the event records conveys a timeline of the physical movement of the one or more assets carrying the one or more passive device.

2. The system of claim 1, wherein the passive report information for the individual passive device is generated by the individual active device in response to the detection of the individual passive device by the individual active device, such that the first passive report information for the first passive device is generated by the first active device in response to a detection of the first passive device by the first active device.

3. The system of claim 2, wherein the first active device includes one or more sensors configured to generate output signals, and wherein the first active device is configured to generate the first passive report information by:
detecting the first passive device based on the output signals of the one or more sensors;
identifying the first passive device; and/or
determining the first location of the first passive device based on the output signals of the one or more sensors.

4. The system of claim 3, wherein the first active device is configured to effectuate communication of the first passive report information to the one or more physical processors over a wireless communications network in response to generating the first passive report information.

5. The system of claim 1, wherein the first active report information for the first active device is generated by the first active device in response to the first active device coming into a predefined geofence.

6. The system of claim 1, wherein the first active report information for the first active device is generated by the first active device in response to the detection of the first passive device by the first active device.

7. The system of claim 6, wherein the first active device is configured to generate the first active report information by:
in response to the detection of the first passive device by the first active device:
obtaining identification information conveying the identification of the first active device; and
obtaining location information conveying the second location of the first active device.

8. The system of claim 7, wherein the first active device is configured to effectuate communication of the first active report information to the one or more physical processors over a wireless communications network in response to generating the first active report information.

9. The system of claim 8, wherein the first active device is configured to:
in a recurring manner until the first passive device is detected by a second active device or the first active device is detected within a predefined geofence:
obtain the location information conveying current location of the first active device; and
effectuate communication of the location information to the one or more physical processors over the wireless communications network.

10. The system of claim 1, wherein the first passive device is a barcode or RFID tag, and the first active device is a mobile computing platform.

11. A method to track assets using active devices and passive devices, the method comprising:
obtaining passive report information for one or more passive devices, the passive report information conveying detection of the one or more passive devices, identification of the one or more passive devices, and location of the one or more passive devices;
obtaining active report information for one or more active devices, the active report information conveying identification of the one or more active devices and location of the one or more active devices; and
generating event records based on the passive report information and the active report information, the events records being indicative of physical movement of one or more assets carrying the one or more passive devices, the event records including:
passive reporting event records, an individual passive reporting event record being generated in response to the passive report information for an individual passive device being obtained, wherein the individual passive reporting event record includes at least the identification and the location of the individual passive device, such that a first passive reporting event record is generated in response to obtaining first passive report information for a first passive device, the first passive reporting event record including an identification of the first passive device and a first location of the first passive device;
active reporting event records, an individual active reporting event record being generated in response to the active report information for an individual active device being obtained, wherein the individual active reporting event record includes at least the identification and the location of the individual active device, such that a first active reporting event is generated in response to obtaining first active report information for a first active device, the first active reporting event record including an identification of the first active device and a second location of the first active device; and
wherein the event records are organized to generate a series of the event records, wherein the series organizes the event records in chronological order with respect to the active report information and the passive report information being obtained, such that the series of the event records conveys a timeline of the physical movement of the one or more assets carrying the one or more passive device.

12. The method of claim 11, wherein the passive report information for the individual passive device is generated by the individual active device in response to the detection of the individual passive device by the individual active device, such that the first passive report information for the first passive device is generated by the first active device in response to a detection of the first passive device by the first active device.

13. The method of claim 12, wherein the first active device includes one or more sensors configured to generate output signals, and wherein the method further comprises generating the first passive report information by:
detecting, by the first active device, the first passive device based on the output signals of the one or more sensors;
identifying, by the first active device, the first passive device; and/or
determining, by the first active device, the first location of the first passive device based on the output signals of the one or more sensors.

14. The method of claim 13, wherein the first active device is configured to effectuate communication of the first passive report information over a wireless communications network in response to generating the first passive report information.

15. The method of claim 11, wherein the first active report information for the first active device is generated by the first active device in response to the first active device coming into a predefined geofence.

16. The method of claim 11, wherein the first active report information for the first active device is generated by the first active device in response to the detection of the first passive device by the first active device.

17. The method of claim 16, further comprising generating the first active report information by:
in response to the detection of the first passive device by the first active device:
obtaining, by the first active device, identification information conveying the identification of the first active device; and
obtaining, by the first active device, location information conveying the second location of the first active device.

18. The method of claim 17, wherein the first active device is configured to effectuate communication of the first active report information over a wireless communications network in response to generating the first active report information.

19. The method of claim 18, further comprising:
in a recurring manner until the first passive device is detected by a second active device or the first active device is detected within a predefined geofence:
obtaining, by the first active device, the location information conveying current location of the first active device; and
effectuating communication, by the first active device, of the location information over the wireless communications network.

20. The method of claim 11, wherein the first passive device is a barcode or RFID tag, and the first active device is a mobile computing platform.
